(19) United States
(12) Patent Application Publication
(10) Pub. No.: US 2019/0213640 A1
(43) Pub. Date: Jul. 11, 2019

(54) DYNAMIC LOCATION TYPE DETERMINATION BASED ON INTERACTION WITH SECONDARY DEVICES

(71) Applicant: International Business Machines Corporation, Armonk, NY (US)

(72) Inventors: Jeremy Buchman, Phoenix, AZ (US); Lisa Seacat DeLuca, Baltimore, MD (US); Jeremy A. Greenberger, Foster City, CA (US)

(21) Appl. No.: 15/867,593

(22) Filed: Jan. 10, 2018

(51) Int. Cl. G06Q 30/02; H04W 4/021

(52) U.S. Cl. CPC G06Q 30/0261; H04L 67/22; H04W 4/021

(57) ABSTRACT

According to one embodiment, a method includes determining, using a location feature of a mobile device of a user, a plurality of locations visited by the user. The method also includes storing indication of one or more locations from the plurality of locations visited by the user along with a length of time in which the user visited each of the one or more locations. In addition, the method includes determining whether a first location of the one or more locations qualifies as a personalized location specific to the user based on interaction of the mobile device with one or more secondary devices at the first location. Moreover, the method includes categorizing the first location as a first personalized location selected from a plurality of personalized locations in response to a determination that the first location is a personalized location specific to the user.

### BACKGROUND

The present invention relates to geographical location detection, and more specifically to detecting which locations visited by a user qualify as a personalized location type based on interactions with secondary devices.

The percentage of the population that uses a personal mobile computing device (mobile phone, tablet, smartwatch, etc.) increases every year. People use their mobile devices for a countless number of different tasks. Moreover, mobile devices are increasingly used as a gateway to the Internet, and used for traditional online activities, including online shopping. When a person is shopping online, often times they are presented with product recommendations in an attempt to influence an ultimate purchasing decision, whether it be display of a particular product on a current website, or display of one or more products available on a different website. Traditionally, these product recommendations are based on content that the person is searching for, search histories, or interest in similar websites.

In a related technology, a geofence is a virtual geographic boundary that defines an area around a point in the physical world, often pinpointed using global positioning satellite (GPS), radio frequency identification (RFID), or some other suitable location-generating technology. A geofence may be used to respond to a certain device entering or exiting from the defined area dictated by the geofence. The geofence may be centered using latitude and longitude coordinates or some other suitable location designations.

Software and application developers have utilized geofences to enhance mobile software and applications to enhance a user's interaction with the mobile device in relation to the user's physical location in the world. However, a geofence must be set up explicitly. Moreover, tracking software on a mobile device may be able to determine a specific location of the mobile device and its proximity to the geofence, but is incapable of determining what that specific location is with respect to the particular user of the mobile device, e.g., home, business, friend's house, etc.

### SUMMARY

In one embodiment, a system includes a processing circuit and logic integrated with the processing circuit, executable by the processing circuit, or integrated with and executable by the processing circuit. The logic is configured to cause the processing circuit to determine, using a location feature of a mobile device of a user, a plurality of locations visited by the user. The logic is also configured to cause the processing circuit to store indication of one or more locations from the plurality of locations visited by the user along with a length of time in which the user visited each of the one or more locations. In addition the logic is configured to cause the processing circuit to determine whether a first location of the one or more locations qualifies as a personalized location specific to the user based on interaction of the mobile device with one or more secondary devices at the first location. Moreover, the logic is configured to cause the processing circuit to categorize the first location as a first personalized location selected from a plurality of personalized locations in response to a determination that the first location is a personalized location specific to the user.

According to another embodiment, a computer program product includes a computer readable storage medium having program instructions embodied therewith. The embodied program instructions are executable by a processing circuit of a mobile device to cause the processing circuit to determine, by the processing circuit using a location feature of the mobile device, a plurality of locations visited by a user. The embodied program instructions are also executable to cause the processing circuit to store, by the processing circuit, indication of one or more locations from the plurality of locations visited by the user along with a length of time in which the user visited each of the one or more locations. In addition, the embodied program instructions are executable to cause the processing circuit to determine, by the processing circuit, whether a first location of the one or more locations qualifies as a personalized location specific to the user based on interaction of the mobile device with one or more secondary devices at the first location. Moreover, the embodied program instructions are executable to cause the processing circuit to categorize, by the processing circuit, the first location as a first personalized location selected from a plurality of personalized locations in response to a determination that the first location is a personalized location specific to the user.

According to yet another embodiment, a method includes determining, using a location feature of a mobile device of a user, a plurality of locations visited by the user. The method also includes storing indication of one or more locations from the plurality of locations visited by the user along with a length of time in which the user visited each of the one or more locations. In addition, the method includes determining whether a first location of the one or more locations qualifies as a personalized location specific to the user based on interaction of the mobile device with one or more secondary devices at the first location. Moreover, the method includes categorizing the first location as a first personalized location selected from a plurality of personalized locations in response to a determination that the first location is a personalized location specific to the user. Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a system that provides dynamic personalized location services, according to one embodiment.

FIG. 5 shows a system that provides notifications to a user based on personalized locations, according to one embodiment.

FIG. 6 shows a flowchart of a method, according to one embodiment.

FIG. 7 shows a flowchart of a method, according to another embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The term “about” as used herein indicates the value preceded by the term “about,” along with any values reasonably close to the value preceded by the term “about,” as would be understood by one of skill in the art. When not indicated otherwise, the term “about” denotes the value preceded by the term “about” ±10% of the value. For example, “about 10” indicates all values from and including 9.0 to 11.0.

The following description discloses several preferred embodiments of systems, methods, and computer program products for providing location type determination services to a user.

In one general embodiment, a system includes a processing circuit and logic integrated with the processing circuit, executable by the processing circuit, or integrated with and executable by the processing circuit. The logic is configured to cause the processing circuit to determine, using a location feature of a mobile device of a user, a plurality of locations visited by the user. The logic is also configured to cause the processing circuit to store indication of one or more locations from the plurality of locations visited by the user along with a length of time in which the user visited each of the one or more locations. In addition the logic is configured to cause the processing circuit to determine whether a first location of the one or more locations qualifies as a personalized location specific to the user based on interaction of the mobile device with one or more secondary devices at the first location. Moreover, the logic is configured to cause the processing circuit to categorize the first location as a first personalized location selected from a plurality of personalized locations in response to a determination that the first location is a personalized location specific to the user.

According to another general embodiment, a computer program product includes a computer readable storage medium having program instructions embodied therewith. The embodied program instructions are executable by a processing circuit of a mobile device to cause the processing circuit to determine, by the processing circuit using a location feature of the mobile device, a plurality of locations visited by a user. The embodied program instructions are also executable to cause the processing circuit to store, by the processing circuit, indication of one or more locations from the plurality of locations visited by the user along with a length of time in which the user visited each of the one or more locations. In addition, the embodied program instructions are executable to cause the processing circuit to determine, by the processing circuit, whether a first location of the one or more locations qualifies as a personalized location specific to the user based on interaction of the mobile device with one or more secondary devices at the first location. Moreover, the embodied program instructions are executable to cause the processing circuit to categorize, by the processing circuit, the first location as a first personalized location selected from a plurality of personalized locations in response to a determination that the first location is a personalized location specific to the user.

According to yet another general embodiment, a method includes determining, using a location feature of a mobile device of a user, a plurality of locations visited by the user. The method also includes storing indication of one or more locations from the plurality of locations visited by the user along with a length of time in which the user visited each of the one or more locations. In addition, the method includes determining whether a first location of the one or more locations qualifies as a personalized location specific to the user based on interaction of the mobile device with one or more secondary devices at the first location. Moreover, the method includes categorizing the first location as a first personalized location selected from a plurality of personalized locations in response to a determination that the first location is a personalized location specific to the user.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

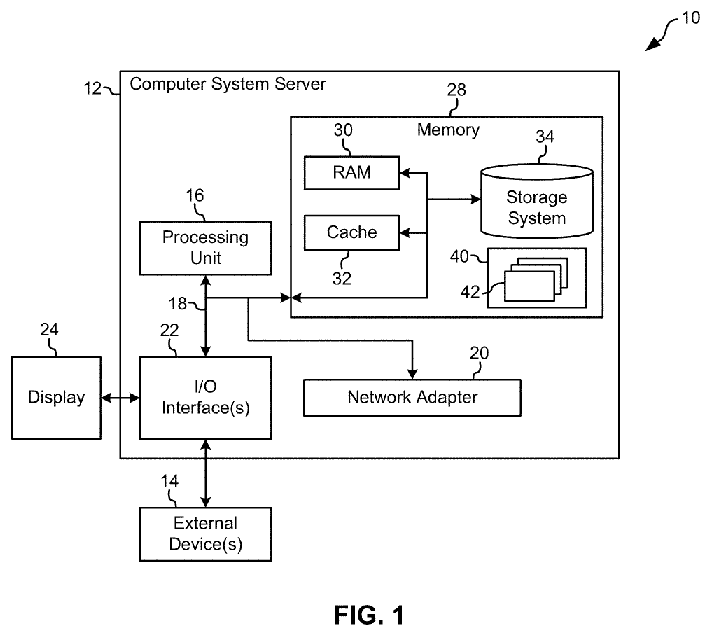

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, a processing unit 16 (which may include one or more processors), a system memory 28, and a bus 18 that couples various system components, including the system memory 28, to the processing unit 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

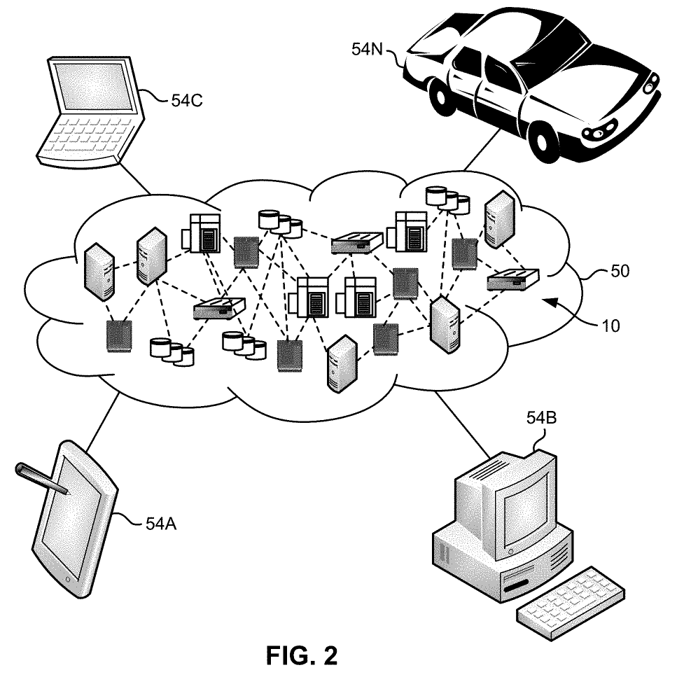

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or mobile telephone 54A, desktop computer 54B, laptop computer 54C, and/or automobile computer system 54N may communicate. Cloud computing nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that cloud computing nodes 10 and cloud computing environment 50 can communicate with any type of computerized device over any type of network and/or network addressable connection (e.g., using a web browser).

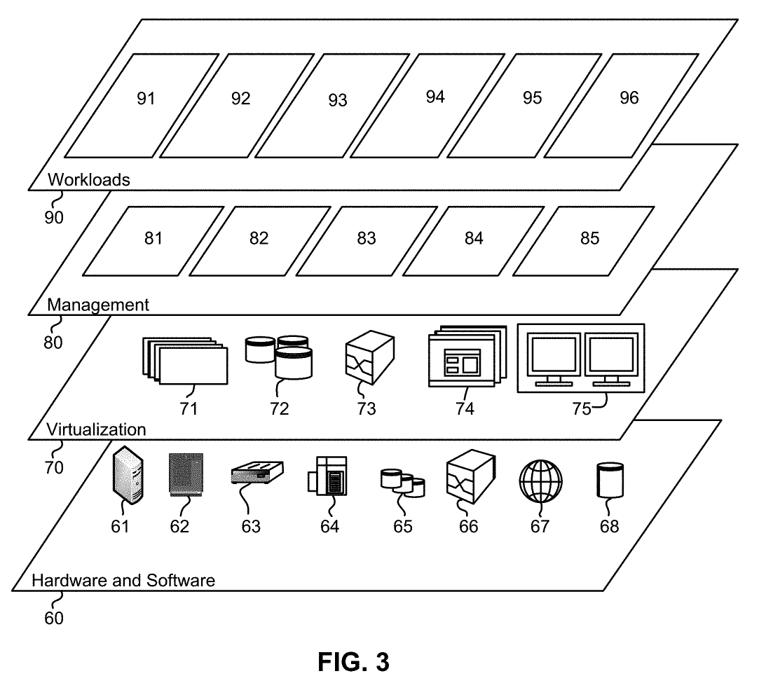

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and dynamic personalized location services 96.

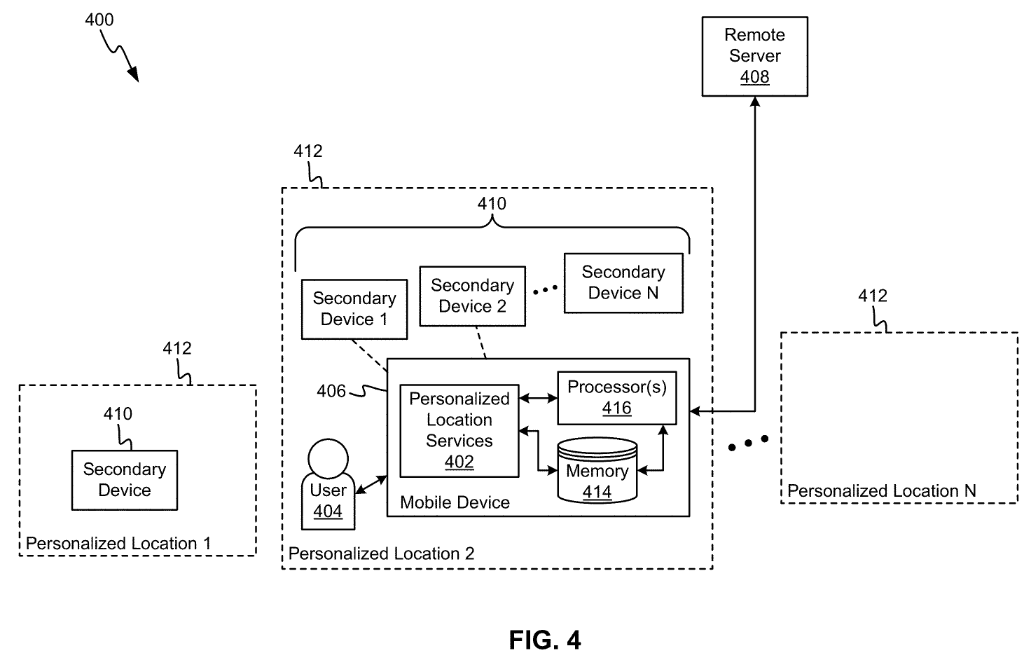

With reference to FIG. 4, which shows a system 400 according to one embodiment, dynamic personalized location services 402 may be offered to a user 404 on an as-needed basis (service on demand). In one approach, these dynamic personalized location services 402 may be implemented using a mobile device 406 of the user 404, which may be in electronic communication with a remote server 408 (which may operate within a cloud-based network in some approaches) that is configured to provide information and data for implementation of the dynamic personalized location services 402. In an alternate approach, these dynamic personalized location services 402 may be installed on the mobile device 406 of the user 404, and may be configured to provide the dynamic personalized location services 402 without interacting with the remote server 408. In either approach, conventional location services, such a GPS location, Wi-Fi enabled location, cell tower triangulation, IBM® Device Location Awareness (DLA), etc., may be used to determine a current location of the mobile device 406.

According to various embodiments, the mobile device 406 may be any computing device known in the art that is capable of being transported with a user 404 and further configured to provide and/or obtain a current location of the computing device and/or the user thereof. In various non-limiting examples, the mobile device 406 may be a mobile telephone, a smartphone, a tablet computer, a smartwatch, a laptop computer, a wearable computing device (“wearable”) like smartwatches, heartrate monitors, a fitness tracker, etc., a wearable thin film computing device (like a temporary computer tattoo), a computing device that is embedded in clothing, shoes, a fashion accessory, etc. Some current products on the market that are considered to be mobile devices include, but are not limited to, Apple® iPhone series smartphones, Samsung® Galaxy series smartphones and tablets, Apple® Watch series wearables, Apple® iPad series tablets, Google® Nexus and Pixel series smartphones, Nokia® smartphones, Garmin® handheld GPS devices and wearables, etc.

The mobile device 406 includes one or more processors 416 (of a type known in the art) in electrical communication with a memory 414 (of a type known in the art) and dynamic personalized location services 402, which may be provided by the one or more processors 416, by the remote server 408, and/or by a separate module or processor of the mobile device 406 dedicated to providing the dynamic personalized location services 402.

In one embodiment, the dynamic personalized location services 402 include determining whether the user 404 is visiting a personalized location that is specific to the particular user 404. This determination may be based on determination of a current location of the user 404 and a further determination of whether the current location is within a geofence boundary or some other predefined virtual perimeter of a pre-set and predetermined personalized location of the user 404. Personalized locations may be different for each user, and the identification of what type of personalized locations are being sought is made prior to determining whether a current location qualifies as a personalized location for a particular user.

Current technologies attempt to detect “locations of interest” for a particular mobile device based on a frequency in which the user visits one or more locations over time. One problem with this method of determining locations of interest for a particular user is that the identity of the location is guessed, since the only information available to determine the location's identity is that the user visits the location frequently and stays at the location for certain periods of time. For example, traditional methods respond to a user staying at a location overnight by guessing that the location is “home,” without having any further information or knowledge as to what the location actually means to the user.

In order to overcome this deficiency, the dynamic personalized location services 402 include determining the existence of secondary device(s) 410 that may electronically couple to the user's mobile device 406, communicate with the user's mobile device 406, communicate with another secondary device that is in communication with the user's mobile device 406, and/or be used by the user's mobile device 406. The secondary device(s) 410 may be accessible at various locations that are visited by the user 404, and the presence of one or more secondary devices 410 at these various locations, and the interactions therewith by the user's mobile device 406 or some other electronic device at one of these various locations, may be used to define which personalized location 412 is actually being visited by the user 404, in addition to providing context as to the relationship of the current location to the user 404.

In one embodiment, a secondary device 410 may be any electronic device capable of communicating with and/or electronically coupling with the user's mobile device 406 and/or another secondary device 410 which is capable of communicating with and/or electronically coupling with the user's mobile device 406. For example, a location tag for radio frequency identification (RFID) of an object may not communicate directly with the user's mobile device 406, but may communicate with a personal computer at the home of the user 404. The user's mobile device 406 may also communicate with the personal computer, and through this interaction may become aware of the location tag, which would then provide additional information regarding the present location, and possibly other locations visited by the user 404.

Some examples of secondary devices 410 include, but are not limited to, Internet-of-Things (IoT) devices, smartwatches, smart refrigerators, home automation controllers, home automation devices (e.g., smart thermostats, smart sprinkler systems, smart lighting devices, smart garage door openers, smart door locks, smart heating ventilation and air conditioning (HVAC) systems, etc.), wireless routers, wireless printers, television (TV) streaming devices, console gaming devices, network servers, personal computers (PCs), connected automobiles, etc. Some current products on the market that are considered to be secondary devices include, but are not limited to, Amazon® Alexa devices, Amazon® Fire devices, Google® Home devices, Google® Chromecast devices, Android Wear®-based devices, Apple® Watch products, Philips® Hue Smart Lighting products, Nest® devices, August® smart locks, Apple® TV devices, Roku® TV devices, Fitbit® devices, Sony® PlayStation systems, Microsoft® Xbox systems, etc.

According to another embodiment, the use of one or more secondary devices 410 may be detected, and the use of the one or more secondary devices 410 may be tracked. This use of the one or more secondary devices 410 may be stored as metadata associated with the particular location of use in the memory 414, on the remote server 408, and/or in a log, record, table, file, data set, etc., that is accessible to the mobile device 406 and/or the remote server 408. This use may be stored along with an indication of the particular location in which the one or more secondary devices 410 is detected, and a duration of use. All of these values may be stored as characteristics of use for the one or more secondary devices 410. These characteristics of use may be utilized to determine a context that indicates what the particular location is in relation to the user 404, which may result in the location qualifying as a personalized location 412.

According to another embodiment, the use of secondary device(s) 410 may be used to determine that a particular location qualifies as a personalized location 412 and to save the current location as a personalized location 412. Thereafter, a determination may be made as to what kind of personalized location 412 it is from amongst a plurality of predetermined personalized location types. This determination may be made using the characteristics of use for the secondary device(s) 410, along within the context of the interactions between the user 404 and the secondary device(s) 410.

Each personalized location 412 is a physical place in the real world that may be navigated to by the user 404. Moreover, in some approaches, the personalized locations for a particular user will include locations that are frequently visited by the particular user, such that the user will be likely to visit one of the plurality of personalized locations specific to the user more frequently than other locations that are not designated as personalized locations specific to the user. Personalized locations for other users may differ from those for any other user. For example, when home is regarded as a personalized location, one user's home may differ from another user's home, and therefore each user would have a different “home” location. In contrast, for two users who live together, they would share a “home” location as a personalized location specific to each user.

In one approach, personalized locations may be limited and specified for determination based on which types of locations advertisers are interested in, e.g., locations in which an advertiser is willing to provide and pay for notification(s) (e.g., advertisement(s), product recommendation(s), etc.) to be output to a device (e.g., displayed on a screen, audibly output from speakers, etc.) upon one or more users visiting such locations. This specification of personalized locations may be based on content of the notification(s) and/or a specific subgroup of users that the advertiser wants to reach. In these descriptions, an advertiser may be a seller, marketer, producer, or any other entity that is related to and/or associated with creation, distribution, selling, pricing, marketing, and/or providing product(s) and/or service(s) that are described in the notification.

Some exemplary advertisers include, but are not limited to, online retailers (e.g., Amazon.com®, Jet.com®, Alibaba.com®, Overstock.com®, ebay.com®, etc.), traditional retailers (e.g., Walmart®, Best Buy®, Target®, Petco®, etc.), corporations that produce products and/or services (e.g., Apple®, Microsoft®, Samsung®, Google®, IBM®, etc.), restaurants (Cheesecake Factory®, Applebee's®, Denny's®, etc.), service providers (Uber®, Lyft®, taxi services, airport shuttles, Grubhub®, DoorDash®, etc.), and other entities known in the art that would be interested in providing location-based notifications to one or more users.

Groups may be determined based on any known factor or consideration, for example, age and ability to purchase advertised product(s) (e.g., tobacco, prescription pharmaceuticals, alcohol, etc.), wealth of users, purchasing ability of users, education level of users, sophistication of users, likes and dislikes of users, frequently purchased items, time of year, time of day, upcoming holidays, etc.

A personalized location 412 may have a physical and/or mailing address, one or more buildings present at the personalized location, a name (such as business name(s), proper or slang terms used to describe the location, a custom name provided by the user 404, etc.), a telephone number associated with the personalized location, and/or any other known attribute of a physical place, such as being viewable from satellite imagery of the Earth and/or visitable by a real world person. Examples of personalized locations 412 include, but are not limited to, home(s), work or place(s) of business, school(s), governmental office(s), park(s), location(s) specific to sports and/or physical activities, and other physical locations not explicitly described herein, but would be understood to one of skill in the art upon reading the present descriptions.

Examples of personalized locations that are specific to sports and/or physical activities include, but are not limited to, skating rink, racquetball court, tennis court, basketball court, football field, soccer pitch, park, workout studio, gym, health club, yoga studio, Pilates studio, swimming pool, running track, velodrome, etc. These personalized locations may provide access for the user to participate in the respective sport and/or physical activity, to work at the venue, or to watch other people participate in the respective sport and/or physical activity.

Examples of personalized locations that are specific to governmental offices include, but are not limited to, post offices, post office collection boxes, libraries, department of motor vehicles (DMV) buildings, department of transportation (DOT) buildings, roadway maintenance buildings, immigration buildings, capitol buildings, courthouses, city or town halls, county or parish seats, state or provincial capitals, capitol building for a country, president's or prime minister's residence, United Nations (UN) buildings, etc.

Personalized locations for any given user may be spread out geographically from one another, e.g., a person's home versus a person's work versus a person's health club. However, in some instances, different personalized locations may be grouped together in small geographical areas, which dictate that tight boundary constraints are provided for each personalized location so that overlap does not occur between the different locations.

An incredible number of personalized location types may be conceived of, based on desire to determine user(s) presence at such locations, and the ability to make a determination that a user is actually visiting such a location. More useful types of personalized locations are those that a user would dwell at for more than a transitory period of time, e.g., greater than a minimum amount of time in any single visit, such that a user's presence at the location may be determined using the techniques described herein.

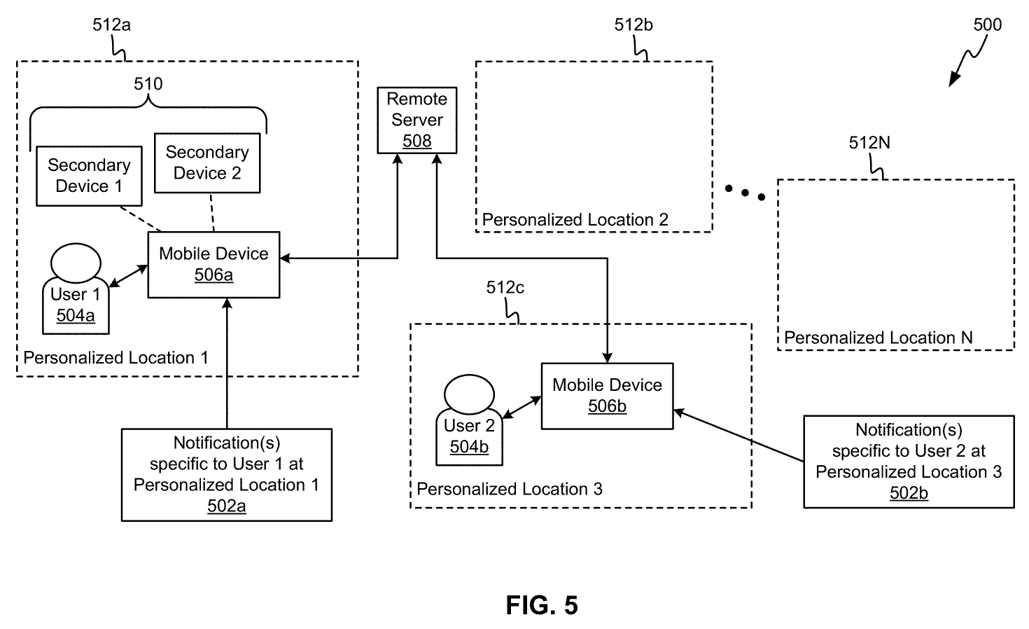

Now referring to FIG. 5, a system 500 for providing notifications 502 (e.g., Notification(s) specific to User 1 at Personalized Location 1 502a, Notification(s) specific to User 2 at Personalized Location 2 502b, etc.) to a user 504 (e.g., User 1 504a, User 2 504b, etc.) based on personalized locations 512 (e.g., Personalized Location 1 512a, Personalized Location 2 512b, Personalized Location 3 512c, . . . , Personalized Location N 512N) is shown according to one embodiment. In this system 500, the notifications 502 (which may include product recommendations) may be output on a mobile device 506 (e.g., User 1's Mobile Device 506a, User 2's Mobile Device 506b, etc.) of the user 504 (such as displayed on a screen of the mobile device 506), and are based on a determination of whether the user 504 is currently visiting a personalized location 512. Moreover, the notifications 502 are determined based on which personalized location 512 of a plurality of personalized locations specific to that particular user 504 is currently being visited by the user 504. This system 500 provides the ability to set and determine locations of interest (personalized locations 512) for a given user 504 that may be used to influence what kind of notification(s) 502, how many notifications 502, and a content of the notification(s) 502, if any, that are sent to the mobile device 506 of the user 504.

In response to a user 504 moving to a different personalized location 512, the notifications 502 that are provided to the user 504 will change such that they are specific to the user 504 and the personalized location 512 in which the user 504 is currently visiting, and not any previously visited personalized location(s). As shown in FIG. 5, because User 1 504a is visiting Personalized Location 1 512a, the Notification(s) 502a provided to the mobile device 506a of User 1 504a is specific to both this particular user—User 1 504a, and this particular location—Personalized Location 1 512a. Likewise, because User 2 504b is visiting Personalized Location 3 512c, the Notification(s) 502b provided to the mobile device 506b of User 2 504b is specific to both this particular user—User 2 504b, and this particular location—Personalized Location 3 512c.

In addition, each user 504 will have individual personalized locations 512 set for that particular user 504, and therefore even if User 1 504a visits Personalized Location 3 512c (which is set up for User 2 504b as previously indicated), no specialized notifications 502 will be provided to User 1 504a unless this location is also set up for User 1 504a as a personalized location 512. Only in response to the actual physical location that corresponds to Personalized Location 3 512c being set up for User 1 504a will the notifications 502 provided to User 1 504a be specific to User 1 504a and the type of location that Personalized Location 3 512c is to User 1 504a.

A notification 502 may include an image of a product and/or service, text that describes the product and/or service, an audio clip related to the product and/or service, a video related to the product and/or service, identification of the current personalized location 512 on which the notification 502 is based, identification of the user 504, and/or any other information relevant to the user 504, product, and/or service described in the notification 502 and current personalized location 512, in various approaches. In more approaches, the notification 502 may include user-selectable link(s) that direct the mobile device 506 to navigate to a particular webpage that allows for ordering of, purchase of, and/or indication of interest in the product and/or service described in the notification 502.

In another embodiment, an action and/or feature may be activated, executed, and/or queued in response to a user 504 entering, dwelling at, and/or exiting a particular personalized location 512. For example, entry of a user 504 to a personalized location 512 that corresponds to the user's home may cause a home automation controller to turn on certain lights within the home. In another example, exit of a user 504 from a personalized location 512 that corresponds to the user's work may cause the user's automobile to start remotely. Such a feature may be useful for a user who lives in a snowy climate in the wintertime in order to defrost the windshield prior to the user's arrival at the automobile.

The determination that the user 504 is visiting a specific personalized location 512 may be used to determine whether to provide a notification 502 to the user on the user's mobile device 506, or whether a notification 502 is not to be delivered to the user 504. Moreover, one or more secondary device(s) 510 at a specific personalized location 512 may be used to further determine which type of notifications 502 to send to the user's mobile device 506.

For example, an advertiser and/or marketer may be interested in providing a notification that includes an advertisement associated with a user being at home, but not an advertisement associated with a user being at work. In another example, an advertiser and/or marketer may be interested in providing a notification that includes an advertisement associated with a user watching a live sporting event played by a professional or collegiate team, but not an advertisement associated with a user participating in the same sport. In another example, an advertiser and/or marketer may desire to recognize a time that is appropriate to provide a notification that includes an advertisement (which may include a product recommendation, sales pitch, production description, coupon, or some other marketing message known in the art) to a user's mobile device, such as in response to the user being near a physical store associated with the advertiser and/or marketer, to track a proximity of a user to the user's home in order to perform some pre-set home automation function(s), etc.

Moreover, in another approach, a notification may include an indication of the specific personalized location that the mobile device has determined the user is currently visiting, and the user may be provided an interface to change this determination to another personalized location or to a default setting. Some exemplary interface interactions include, but are not limited to, clicking on text displaying the current personalized location which may cause a change to another personalized location or a default location setting, display of a drop-down menu which shows a list of selectable personalized locations that the user may choose from, etc. In the default setting in which a personalized location is not selected, default notifications are provided to the mobile device, which may be pre-selected by the advertiser(s) in case a default setting is used and/or the user is not currently located at a personalized location.

In e-commerce applications, an advertiser and/or marketer may desire the ability to send a notification to a user's mobile device in response to the user leaving the user's home, entering the user's office, dwelling in a library, attending a sporting event, attending a school, etc. By determining where these personalized locations exist in the real world for each particular user, a marketing solution may be offered as a service on demand to the advertiser and/or marketer that is hosted in a cloud computing architecture, such as that described in FIGS. 1-3, provided as an application on the user's mobile device, provided on demand by a standalone remote server, etc.

Referring again to FIG. 5, any other division of generating and delivering notifications 502 to the user 504 (such as placing of advertisements, product recommendations, etc., and which advertisements, product recommendations, etc., are output on the user's mobile device 506) based on the user's presence at a specific personalized location 512 may be utilized in the context of the various embodiments described herein, as would be appreciated by one of skill in the relevant art upon reading the present descriptions.

Moreover, in some embodiments, notifications 502 may be provided to the mobile device 506 by a remote server 508. In another embodiment, an indication of the personalized locations 512 may be delivered to the mobile device 506 by the remote server 508, such as in a service on-demand relationship between the server 508 and the mobile device 506.

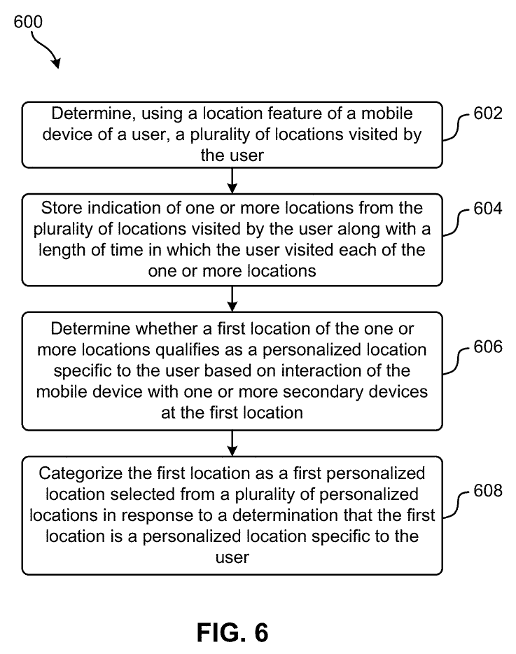

With reference to FIG. 6, a method 600 is shown according to one embodiment. The method 600 may be performed in accordance with the present invention in any of the environments depicted in FIGS. 1-5, among others, in various embodiments. Of course, more or less operations than those specifically described in FIG. 6 may be included in method 600, as would be understood by one of skill in the art upon reading the present descriptions.

Each of the steps of the method 600 may be performed by any suitable component of the operating environment. For example, in various embodiments, the method 600 may be partially or entirely performed by a microprocessor, a server, a cluster of computing devices (e.g., a local cluster, a remote cluster, a cloud network), a mobile computing device, a processing circuit having one or more processors therein, or some other device comprising one or more processors. The processing circuit, e.g., processor(s), chip(s), and/or module(s) implemented in hardware and/or software, and preferably having at least one hardware component, may be utilized in any device to perform one or more steps of the method 600. Illustrative processors include, but are not limited to, a MPU, a CPU, an ASIC, a FPGA, etc., combinations thereof, or any other suitable computing device known in the art.

As shown in FIG. 6, method 600 may start with operation 602, where a plurality of locations visited by a user of a mobile device are determined, using a location feature of the mobile device. Each location is an actual physical place that is visitable by a real world user. The mobile device may be any known type of mobile device, such as a smart phone, tablet, laptop computer, smartwatch, etc.

The location feature of the mobile device may utilize any location technology known in the art, such as GPS, Wi-Fi location, cell tower triangulation, etc.

In one embodiment, the plurality of locations include all physical places in the real world that the user visits, and in a further embodiment, the plurality of locations may only include locations that are visited for more than a predetermined amount of time. The predetermined amount of time may be set and adjusted to cause the mobile device to produce a specific number of candidate locations for further analysis, e.g., the amount of time the user dwells at the location may be adjusted longer or shorter, thereby causing less or more locations to qualify for further analysis.

In operation 604, indication of one or more locations from the plurality of locations visited by the user are stored along with a length of time in which the user visited each of the one or more locations. The indication of the one or more locations may be stored to a memory local to the mobile device, to a remote memory accessible by the mobile device, to a memory of a secondary device electronically coupled to the mobile device, or some combination thereof.

The one or more locations that are chosen from amongst the plurality of locations may be determined based on dwell time, proximity of the location to other locations visited by the user, a time of day that the user visits the location, action(s) performed by the user at the locations, or any other factor known in the art which may indicate a relationship between the user and a specific location.

The length of time in which the user visits and dwells at each of the one or more locations may be tracked using an application on the mobile device and/or by a remote server that is configured to track the current location of the mobile device.

In operation 606, a determination is made as to whether a first location of the one or more locations qualifies as a personalized location specific to the user. This determination is based on interaction of the mobile device with one or more secondary devices at the first location. The one or more secondary devices are separate, distinct devices from the remote server and the mobile device of the user, but may still be owned and/or operated by the user.

In one embodiment, a personalized location specific to the user is a physical location previously visited by the user that has predetermined characteristics that are determinable from the interaction of the mobile device with the one or more secondary devices. Moreover, a personalized location may be indicated by a location that is visited frequently by the user and has a significant connection to the user. Some predetermined characteristics include, but are not limited to, visit frequency, length of visits, proximity of the location to other personalized locations, user-provided input confirming that a certain location qualifies as a personalized location, etc.

In a further approach, method 600 may include detecting the existence and/or presence of the one or more secondary devices at the first location based on the interaction of the mobile device with the one or more secondary devices at the first location.

Furthermore, the interaction may include electronic coupling of the mobile device with the one or more secondary devices, sending of information from the mobile device to the one or more secondary devices, receiving information at the mobile device from the one or more secondary devices, the mobile device using one or more features of the one or more secondary devices, the mobile device causing an action by the one or more secondary devices, or some other type of interaction that is known in the art that takes place between electronic devices wirelessly.

In one approach, activity of the one or more secondary devices may be monitored using the mobile device in order to determine what type of secondary devices are being utilized at the first location, how they are being used, how long they are used, what events take place before, during, and after use of the secondary devices, etc., in order to more thoroughly understand what the secondary devices are, and what type of place the first location is to the user (e.g., whether it qualifies as a personalized location for the user).

In operation 608, the first location is categorized as a first personalized location from amongst a plurality of personalized locations (that are pre-set on the mobile device prior to categorization of the first location) in response to a determination that the first location qualifies as a personalized location specific to the user. In operation 608, the type of personalized location is chosen for the first location from amongst the types listed in the plurality of personalized locations, e.g., home, work, park, school, etc.

For example, if the one or more secondary devices includes a Fitbit® fitness tracker, and the fitness tracker indicates that the user is asleep during long periods of time in the nighttime at the first location, then the type of personalized location may be selected as “home.” In another example, if the one or more secondary devices located at the first location includes a Wi-Fi router that identifies as belonging to a certain corporation that employs the user, then in response to the mobile device coupling to the Wi-Fi router at the first location, the type of personalized location may be selected as “work.”

The plurality of personalized locations may be, without limit, any of the following types of locations specific to the user: home, a family members' home, a friend's home, work, a temporary office, place of business, retail store, health club, school, hotel, vacation location, governmental office, park, sports field, workout studio, yoga studio, swimming pool, post office, library, and other known types of locations that are visitable by the user.

According to one embodiment, method 600 may include outputting, to the user, a request for confirmation that the first personalized location is correctly categorized. For example, should the first personalized location be categorized as the user's home, a message may be displayed on the user's mobile phone asking whether the user is currently at home. The request may be output as a graphic or text on a display of the mobile device, audibly via a speaker of the mobile device, and/or via a secondary device other than the mobile device that is monitored and/or likely to be utilized by the user, e.g., a personal computer of the user at work or at home, a tablet, a smartwatch, etc.

Method 600 may further include receiving a response to the request provided by the user, such as via a graphical user interface (GUI) of the mobile device, voice acknowledgement to an audio question posed by the mobile device, a gesture, nod, blink, etc., of the user, or some other known method of providing a response to a query known in the art. In response to the user indicating that the first personalized location is not correctly categorized in the response, the first personalized location is discarded (i.e., the first location is no longer categorized as a personalized location). In a further approach, the user may provide a category for the current location (or a location previously visited), such as from a drop-down menu, from a list, in a text box, etc. In this way, the user may identify and/or alter a personalized location manually, via a request provided on the user's mobile device that is output in response to an attempt to categorize a location as a personalized location.

In a further embodiment, method 600 may include providing context as to a relationship between the first location and the user based on the interaction of the mobile device with the one or more secondary devices at the first location. This context may include what type of place the first location is (e.g., house, business, apartment, park, sporting venue), why the user visits the first location, how long the user stays at the first location on average, how popular the first location is amongst all locations visited by the user, etc.

According to another embodiment, method 600 may include tracking the interaction of the mobile device with the one or more secondary devices at the first location over time. Moreover, the interaction over time may be used to determine a trend of usage of the one or more secondary devices at the first location over time that indicate one or more characteristics of the first location. This trend of usage may be determinative of whether the first location should remain designated as a personalized location specific to the user.

This trend may be used to determine which of the plurality of personalized locations specific to the user most likely resembles activities that are performed at one of the defined types of personalized locations designated for the specific user. For example, use of a fitness tracker or smartwatch that tracks sleep may indicate that the user is at home or some other location typically having sleeping accommodations, such as a friend's home, relative's home, hotel, vacation spot, etc. In another example, use of a home automation controller is indicative of the user being at home, as typically such a device would not be accessed by a visitor to someone else's home. According to another example, use of a smartwatch to search for directions to a rental car office may indicate that the user is on vacation or a business trip, and any extended time the user spends in the nighttime at a single location while in proximity to the search for the rental car office may be indicated as a hotel, particularly when the user's home is already established for the user.

In a further embodiment, method 600 may include categorizing the first location as an uncategorized location that is not specific to the user in response to a change in the interaction of the mobile device with the one or more secondary devices at the first location which indicates that the first location no longer qualifies as the first personalized location. This change in the interaction may be determined based on the trend that is tracked of the interaction. For example, if the user no longer visits a particular location, then it may be deduced that the location is no longer associated with the user in any meaningful way. Furthermore, if a user accesses a home automation controller at a different location than has been previously designated as the user's home, then the new location may be updated as the user's home, or added as a second home, depending on other characteristics and interactions between the user and secondary devices at the various locations.

According to another embodiment, method 600 may include outputting the first personalized location to one or more advertisers for use in provision of notifications to the mobile device (such as displaying, playing an audio clip, playing a video, etc.). The one or more advertisers may utilize the first personalized location to refine and enhance notifications that are output to a mobile device of the user in response to the user visiting the first location, as described in FIG. 5.

Referring again to FIG. 6, method 600 continuously monitors for additional and/or altered secondary device interactions, and as more data is collected, the categorization of each of the plurality of personalized locations may be adjusted to accurately reflect the relationship to the user over time. Moreover, the one or more advertisers may utilize the accurate personalized locations to send targeted notifications to the user that will have the most impact on the user in a dynamic fashion to increase the success of any promotions, advertisements, coupons, etc., that are included in the notifications, based on the user interacting with the personalized locations, such as home, work, etc., given the user's secondary device interactions at these personalized locations.

In one example, with the caveat that certain types of secondary devices are more common in certain types of environments regardless of the amount of time a user spends at the different locations, e.g., at work vs. at home vs. at school, information about the location may be obtained from interactions with the secondary devices. A user's fitness tracker tends to record activities unique to certain types of personalized location. For example, if the counter is actively increasing while the user is not moving geographically, it is indicative of the user being at a gym or fitness club. If a smartwatch records sleep, the user is typically at home, and if a smartphone records an unchanged step count for long periods of time during business hours and during the work week, the user is typically at work.

In this example, assume that a user travels to a different city for a business trip, and the office building she is working in is uncategorized as a personalized location. In this scenario, in response to a fitness tracker indicating a near constant step count for long periods of time during a work day and during business hours, it suggests that the user is working at a temporary site, and such site may be registered just like the personalized location already designated as “work” for this user for purposes of notification generation. Similarly, in response to the user asking a smartwatch for Yelp® reviews of restaurants in the area, the next location that the user arrives at may be indicated as being a restaurant, and notifications may be provided for bars, lounges, and/or dessert locations near to the restaurant in response to the user leaving the restaurant.

Various different location-based segmentation or profiling of the user may be defined based on the user's interaction with secondary devices. Moreover, notification provision may be based on this location-based segmentation or profiling of the user after determining personalized locations specific to the user.

Method 600 may be implemented in a system and/or a computer program product. For example, a system may include a processing circuit and logic integrated with the processing circuit, executable by the processing circuit, or integrated with and executable by the processing circuit. By integrated with, what is meant is that the processing circuit is a hardware processor that has hardcoded logic included therewith, such as an ASIC, a FPGA, etc. By executable by, what is meant is that the processor is configured to execute software logic to achieve functionality dictated by the software logic, with the processor possibly being a MPU, a CPU, a microprocessor, etc. The logic is configured to cause the processing circuit to perform method 600.

In another example, a computer program product may include a computer readable storage medium having program instructions embodied therewith. The computer readable storage medium may be any suitable storage device known in the art that is configured to store and allow computer access to information stored therein. The embodied program instructions are executable by a processing circuit to cause the processing circuit to perform method 600.

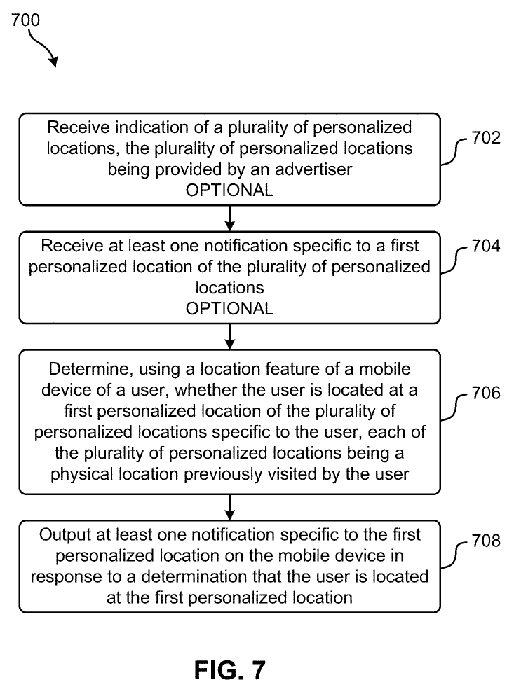

Now referring to FIG. 7, a method 700 is shown according to one embodiment. The method 700 may be performed in accordance with the present invention in any of the environments depicted in FIGS. 1-5, among others, in various embodiments. Of course, more or less operations than those specifically described in FIG. 7 may be included in method 700, as would be understood by one of skill in the art upon reading the present descriptions.

Each of the steps of the method 700 may be performed by any suitable component of the operating environment. For example, in various embodiments, the method 700 may be partially or entirely performed by a microprocessor, a server, a cluster of computing devices (e.g., a local cluster, a remote cluster, a cloud network), a mobile computing device, a processing circuit having one or more processors therein, or some other device comprising one or more processors. The processing circuit, e.g., processor(s), chip(s), and/or module(s) implemented in hardware and/or software, and preferably having at least one hardware component, may be utilized in any device to perform one or more steps of the method 700. Illustrative processors include, but are not limited to, a MPU, a CPU, an ASIC, a FPGA, etc., combinations thereof, or any other suitable computing device known in the art.

As shown in FIG. 7, method 700 may start with optional operation 702, where indication of a plurality of personalized locations (or a single personalized location) is received. The indication of the plurality of personalized locations includes at least a name and/or type of personalized location (e.g., home, work, school, health club, park, hotel, post office, sports venue, etc.), and may further include distinguishing features of the specific personalized location(s) that enables determination of the personalized location(s) when a user visits such location(s). Such distinguishing features may include a name of a specific type of personalized location, a company that owns or provides the personalized location, locations of each specific physical location of a particular type of personalized location, etc.

In one embodiment, the indication of the plurality of personalized locations may be created by and/or provided by an advertiser and/or marketer that intends to provide one or more notifications related to one or more of the personalized locations.

Where a particular physical location that corresponds to one of the plurality of personalized locations exists in the real world for a specific user may be determined based on information accessible to a device (such as a mobile device of the user) that executes method 700 in accordance with embodiments described herein.

In one approach, the indication of the plurality of personalized locations may be sent from an advertiser and/or marketer to the mobile device of the user. In this way, the advertiser and/or marketer may choose which type of personalized location to track for the user, and be alerted any time that the user enters, dwells at, and/or exits the types of personalized locations chosen, in order to have a notification sent to the user, as discussed herein.

The plurality of personalized locations may be, without limit, any of the following types of locations specific to the user: home, a family members' home, a friend's home, work, a temporary office, place of business, retail store, health club, school, hotel, vacation location, governmental office, park, sports field, workout studio, yoga studio, swimming pool, post office, library, or other known types of locations that are visitable by the user.

In optional operation 704, at least one notification specific to a first personalized location of the plurality of personalized locations may be received. In one embodiment, the at least one notification may be provided by the advertiser to be output on the mobile device in response to the user visiting the first personalized location. In another embodiment, a governmental entity may provide a notification that is specific to a user entering a governmental facility that may direct the user on using services in the building. Of course, many other such uses may be conceived by one of skill in the art upon reading the present descriptions.

The at least one notification specific to the first personalized location may be of any type known in the art, such as an advertisement, a coupon, a product recommendation, an introductory splash page and/or video, a banner, a text statement, an audio clip, an advisory or informational message, etc.

In operation 706, a location of the user is determined, using a location feature of a mobile device of the user, to determine whether the user is located at and/or interacting with a physical location in the real world that qualifies as one of the plurality of personalized locations specific to the user (hereafter the first personalized location). Each of the plurality of personalized locations are a physical location previously visited by the user which is specific to the user.

The location feature of the mobile device may be any location technology known in the art, such as GPS, Wi-Fi location, cell tower triangulation, etc.

Interaction with a personalized location includes the user entering, dwelling at, and/or exiting the personalized location. Any of these actions alone or in combination with another action may be regarded as an interaction with the personalized location.

In one embodiment, the indication of the plurality of personalized locations may be received prior to determining whether the user is located at the first personalized location.

In operation 708, in response to a determination that the user is located at the first personalized location, the at least one notification specific to the first personalized location is output to the mobile device. Outputting the notification to the mobile device may include displaying on a screen of the mobile device, audibly playing an audio clip using a speaker of the mobile device, alerting with voice and/or sound, activating one or more lights and/or vibrational features of the mobile device, etc.

In various embodiments, displaying on the mobile device may include the at least one notification being displayed within an application that is executing on the mobile device (such as a shopping application, a web browser, a navigation application, etc.), on a task bar and/or ribbon that is displayed as part of an operating system of the mobile device, and/or as a pop-up on a portion of the display of the mobile device.

In one embodiment, the at least one notification specific to the first personalized location of the plurality of personalized locations may be received prior to displaying the at least one notification specific to the first personalized location.

In another embodiment, each of the personalized locations may have a geofence established around the respective personalized location, thereby allowing for determination of whether the user's mobile device is within the geofence and how long the user's mobile device remains within the geofence. A geofence is configured to virtually indicate physical boundaries of a location in the real world.

Moreover, the user's mobile device may be used to determine whether the user dwells at one of the personalized locations and how long the user dwells at the personalized location. In addition, the user's mobile device may be used to determine whether the user exits one of the personalized locations. Entry and exit from a personalized location may be determined based on the user's mobile device passing into and passing out of, respectively, a geofence established for the personalized location.

In this embodiment, method 700 may further include determining whether the mobile device is within a geofence of the first personalized location. In this case the geofence virtually indicates physical boundaries of the first personalized location.

Moreover, in another embodiment, the user is considered to be within the geofence in response to the user's mobile device entering, exiting, and/or dwelling within the geofence and an area surrounding the first personalized location that extends at least about 10% beyond the physical boundaries of the first personalized location. This 10% extends the physical boundaries of the first personalized location to include a three-dimensional volume that surrounds the actual physical boundaries of the first personalized location in all directions, thereby allowing for the user to be visiting near the first personalized location, but not actually within the physical boundaries of the first personalized location, and still trigger the notification to be sent to the mobile device.

In one embodiment, method 700 may include determining which physical location(s) visited by the user qualify as one of the one or more personalized locations. This determination may be based on techniques described in FIG. 6 in one embodiment. In other embodiments, techniques that are known to those of skill in the art may be used to make this determination.

Referring again to FIG. 7, in accordance with one embodiment, method 700 may include selecting the at least one notification specific to the first personalized location from amongst a plurality of notifications prior to displaying the at least one notification to the mobile device. In this embodiment, each of the plurality of notifications are assigned to at least one of the plurality of personalized locations. Moreover, each of the personalized locations are configured to be output to the mobile device in response to the user being located at a personalized location assigned to a particular notification from the plurality of notifications.

In this embodiment, there may be more than one notification that is assigned to be output in response to the user visiting the first personalized location; however, there may be a limit to the number of notifications that can be output to the mobile device in a practical sense without overwhelming the resources of the mobile device and/or causing the user to respond negatively to such notifications. Therefore, less than the total available notifications (such as only 1 or 2) may be output at any one time in response to the user being detected at the first personalized location.

For example, assume that an advertiser provides a notification that includes an advertisement for paper towels, and the advertiser chooses for this notification to be output on the mobile device of the user on a predefined schedule in response to the user entering the user's home (which would be considered to be the first personalized location). In this endeavor, the advertiser is anticipating that the user will be interested in the paper towel advertisement because the user is at home, and not somewhere else, like work, school, a park, etc. The schedule may include every time, every nth time (where n is an integer of one or more), once a day, once a week, once a month, a certain amount of time after a previous purchase, etc.

According to another embodiment, method 700 may include outputting at least one default notification on the mobile device that is not specific to any of the plurality of personalized locations in response to a determination that the user is not located at any of the plurality of personalized locations. In this way, default notifications may be provided that are not specific to specified locations when the user is not visiting such locations. Typically, these default notifications are not specific to location, and may be of a more general type than the notifications provided for specified locations.

In yet another embodiment, method 700 may include determining metadata associated with the first personalized location prior to outputting the notification(s). Metadata may include, but is not limited to, past actions by the user when at the first personalized location, next locations visited frequently after visiting the first personalized location, details about the first personalized location that may affect actions by the user, name of the first personalized location, proximity of the first personalized location to advertisers who provided notifications, etc. In this way, the metadata may be used to determine which notification to output to the mobile device to maximum the likelihood of success for the content of the notification.

For example, assume that the first personalized location is the grandparent's home of the user, and that the user is currently visiting her grandparent's home. Moreover, during the past three visits to her grandparent's home, the user has ordered pizza delivery from restaurant A. In response, restaurant A may provide an advertisement in response to the user being detected at her grandparent's home in one approach. In a second approach, in order to attempt to capture the user's business, restaurant B may provide an advertisement for their products (which may include pizza or some other food type, and preferably would provide delivery of such food) to be output on the mobile device in response to the user currently visiting her grandparent's home.

Moreover, in some approaches, metadata associated with the first personalized location may be provided to a remote server. In response to receiving this metadata, the remote server may provide one or more notifications to the mobile device to be output that are most relevant to the user during this particular visit to the first personalized location based on the metadata, the type of personalized location, and/or some other known factor(s).

For example, if the user is visiting her friend's home, and her friend is a vegetarian (which may be assumed based on past food ordering behavior when at her friend's home), this metadata may be provided to the remote server. In response, the remote server may provide one or more notifications to the mobile device for vegetarian restaurants in the area.

In another example, assume that the user visits his gym very frequently, and, on some occasions, is able to convince his friend to go with him. Although they go to the same gym, his friend does not go very often. Both the user and his friend utilize mobile devices, and through locational tracking, it is noticed that both the user and his friend are at the gym at the same time, moving throughout the facility.

The gym is a personalized location for the user, because he visits this location often, and the location has been set up as a personalized location specific to the user based on his frequent visits. In addition, this location has been determined to be a gym, based on his movements in the facility, fitness tracker activity, the address of the building, etc. Moreover, he typically visits a health store searching for health supplements after his gym visits, which may be provided as metadata related to the gym being a personalized location. In one approach, the user has enabled promotions to be delivered to his mobile device in connection with his gym use. In response to the user's visit to the gym, product recommendations correlated to the gym and tendency to purchase health supplements are provided as the notification to his mobile device (such as for products that he has not previously purchased, but correspond with other purchases, e.g., protein powder, vitamins, weight lifting accessories, etc.).

The friend is not at a personalized location for herself, as she does not visit the gym frequently (or possibly ever before), and it has not been set up as a personalized location specific to her. When the friend searches for recommendations, she will receive default product recommendations that are not particular to the gym, but instead are based on other known factors used in advertising and marketing, such as personal interests (e.g., books purchased, movies watched, clothing bought, etc.).

In additional embodiments, the advertiser may provide notification(s), content of the notification(s), and specific personalized location types (e.g., home, work, park, health club, acquaintance's homes, etc.) in which to output a corresponding notification(s). Moreover, such provision may include indication of specific notifications that should appear first in any listing or notification delivered to a user at a specific personalized location, in one approach. For example, a first advertiser may desire to have a specific product be the first recommendation in response to a person visiting the home of the person, such as Walmart® desiring to have Febreze® product(s) appear first in any product recommendation listing.

The notifications, including product recommendations, may be based on the presence of a user at one or more personalized locations. In an additional approach, additional locations of interest may be suggested to the user, based on the product set being recommended. For example, a personalized location for a first user may be the health store, while a personalized location for a second user may be the grocery store. Assuming that promotions for recommended products in the grocery store that would typically be sold at a health store are provided, the first user may have a suggestion provided to the first user's mobile device to add the grocery store as a “location of interest,” so that the grocery store would then be handled like other personalized locations for the various advertisers and for notifications delivered to the first user's mobile device.

In another embodiment, an uncategorized or default listing may be provided by advertisers to allow for products, services, etc., to be provided for delivering in notifications to a user in response to the user not being detected visiting a personalized location.

Of course, any other techniques for maximizing notification usage may be included in the methods described herein in various combinations.

Method 700 may be implemented in a system and/or a computer program product. For example, a system may include a processing circuit and logic integrated with the processing circuit, executable by the processing circuit, or integrated with and executable by the processing circuit. By integrated with, what is meant is that the processing circuit is a hardware processor that has hardcoded logic included therewith, such as an ASIC, a FPGA, etc. By executable by, what is meant is that the processor is configured to execute software logic to achieve functionality dictated by the software logic, with the processor possibly being a MPU, a CPU, a microprocessor, etc. The logic is configured to cause the processing circuit to perform method 700.

In another example, a computer program product may include a computer readable storage medium having program instructions embodied therewith. The computer readable storage medium may be any suitable storage device known in the art that is configured to store and allow computer access to information stored therein. The embodied program instructions are executable by a processing circuit to cause the processing circuit to perform method 700.

The embodiments and approaches described herein according to numerous embodiments provide for more accurate and successful provision of notifications to mobile device users that are based on a location of the user, and ensures that relevant information is provided to the user at a precise time in which the notification would be beneficial, useful, interesting, etc., to the user based on the current location, and the relevancy of that location to the specific user.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. By integrated with, what is meant is that the processor has logic embedded therewith as hardware logic, such as an ASIC, a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a CPU, an integrated circuit (IC), a graphics processing unit (GPU), etc.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A system, comprising:
a processing circuit; and
logic integrated with the processing circuit, executable by the processing circuit, or integrated with and executable by the processing circuit, the logic being configured to cause the processing circuit to:
determine, using a location feature of a mobile device of a user, a plurality of locations visited by the user;
store indication of one or more locations from the plurality of locations visited by the user along with a length of time in which the user visited each of the one or more locations;
determine whether a first location of the one or more locations qualifies as a personalized location specific to the user based on interaction of the mobile device with one or more secondary devices at the first location; and
categorize the first location as a first personalized location selected from a plurality of personalized locations in response to a determination that the first location is a personalized location specific to the user.

2. The system as recited in claim 1, wherein a personalized location specific to the user is a physical location previously visited by the user that has predetermined characteristics that are determinable from the interaction of the mobile device with the one or more secondary devices.

3. The system as recited in claim 1, wherein the logic is further configured to cause the processing circuit to:
output to the user a request for confirmation that the first personalized location is correctly categorized;
receive a response to the request provided by the user; and
discard the first personalized location in response to the user indicating that the first personalized location is not correctly categorized.

4. The system as recited in claim 1, wherein the logic is further configured to cause the processing circuit to provide context to a relationship between the first location and the user based on the interaction of the mobile device with the one or more secondary devices at the first location.

5. The system as recited in claim 1, wherein the logic is further configured to cause the processing circuit to:
track the interaction of the mobile device with the one or more secondary devices at the first location over time; and
determine a trend of usage of the one or more secondary devices at the first location over time that indicate one or more characteristics of the first location.

6. The system as recited in claim 5, wherein the logic is further configured to cause the processing circuit to:
categorize the first location as an uncategorized location that is not specific to the user in response to a change in the interaction of the mobile device with the one or more secondary devices at the first location which indicates that the first location no longer qualifies as the first personalized location.

7. The system as recited in claim 1, wherein the logic is further configured to cause the processing circuit to:
output the first personalized location to one or more advertisers for use in provision of notifications to the mobile device.

8. A computer program product, the computer program product comprising a computer readable storage medium having program instructions embodied therewith, the embodied program instructions being executable by a processing circuit of a mobile device to cause the processing circuit to:
determine, by the processing circuit using a location feature of the mobile device, a plurality of locations visited by a user;
store, by the processing circuit, indication of one or more locations from the plurality of locations visited by the user along with a length of time in which the user visited each of the one or more locations;
determine, by the processing circuit, whether a first location of the one or more locations qualifies as a personalized location specific to the user based on interaction of the mobile device with one or more secondary devices at the first location; and
categorize, by the processing circuit, the first location as a first personalized location selected from a plurality of personalized locations in response to a determination that the first location is a personalized location specific to the user.

9. The computer program product as recited in claim 8, wherein the embodied program instructions are further executable by the processing circuit to cause the processing circuit to:
output, by the processing circuit, a request for confirmation to the user that the first personalized location is correctly categorized;
receive, by the processing circuit, a response to the request provided by the user; and
discard, by the processing circuit, the first personalized location in response to the user indicating that the first personalized location is not correctly categorized.

10. The computer program product as recited in claim 8, wherein the embodied program instructions are further executable by the processing circuit to cause the processing circuit to provide, by the processing circuit, context to a relationship between the first location and the user based on the interaction of the mobile device with the one or more secondary devices at the first location.

11. The computer program product as recited in claim 8, wherein the embodied program instructions are further executable by the processing circuit to cause the processing circuit to:
track, by the processing circuit, the interaction of the mobile device with the one or more secondary devices at the first location over time; and
determine, by the processing circuit, a trend of usage of the one or more secondary devices at the first location over time that indicate one or more characteristics of the first location.

12. The computer program product as recited in claim 11, wherein the embodied program instructions are further executable by the processing circuit to cause the processing circuit to:
categorize, by the processing circuit, the first location as an uncategorized location that is not specific to the user in response to a change in the interaction of the mobile device with the one or more secondary devices at the first location which indicates that the first location no longer qualifies as the first personalized location.

13. The computer program product as recited in claim 8, wherein the embodied program instructions are further executable by the processing circuit to cause the processing circuit to:
output, by the processing circuit, the first personalized location to one or more advertisers for use in provision of notifications to the mobile device.

14. A method, comprising:
determining, using a location feature of a mobile device of a user, a plurality of locations visited by the user;
storing indication of one or more locations from the plurality of locations visited by the user along with a length of time in which the user visited each of the one or more locations;
determining whether a first location of the one or more locations qualifies as a personalized location specific to the user based on interaction of the mobile device with one or more secondary devices at the first location; and
categorizing the first location as a first personalized location selected from a plurality of personalized locations in response to a determination that the first location is a personalized location specific to the user.

15. The method as recited in claim 14, wherein a personalized location specific to the user is a physical location previously visited by the user that has predetermined characteristics that are determinable from the interaction of the mobile device with the one or more secondary devices.

16. The method as recited in claim 14, further comprising:
outputting to the user a request for confirmation that the first personalized location is correctly categorized;
receiving a response to the request provided by the user; and
discarding the first personalized location in response to the user indicating that the first personalized location is not correctly categorized.

17. The method as recited in claim 14, further comprising providing context to a relationship between the first location and the user based on the interaction of the mobile device with the one or more secondary devices at the first location.

18. The method as recited in claim 14, further comprising:
tracking the interaction of the mobile device with the one or more secondary devices at the first location over time; and
determining a trend of usage of the one or more secondary devices at the first location over time that indicate one or more characteristics of the first location.

19. The method as recited in claim 18, further comprising:
categorizing the first location as an uncategorized location that is not specific to the user in response to a change in the interaction of the mobile device with the one or more secondary devices at the first location which indicates that the first location no longer qualifies as the first personalized location.

20. The method as recited in claim 14, further comprising:
outputting the first personalized location to one or more advertisers for use in provision of notifications to the mobile device.
